(19) United States
(12) Patent Application Publication
(10) Pub. No.: US 2025/0386326 A1
(43) Pub. Date: Dec. 18, 2025

(54) PAGING RANGE FOR A USER EQUIPMENT

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/745,649

(22) Filed: Jun. 17, 2024

(51) Int. Cl. H04W 68/06; H04W 60/04; H04W 68/02

(52) U.S. Cl. CPC H04W 68/06; H04W 60/04; H04W 68/02

(57) ABSTRACT

Various aspects of the present disclosure generally relate to wireless communication. In some aspects, a user equipment (UE) may signal a preferred paging range for a paging procedure to a network entity, and the network entity may configure the UE with a paging range for the paging procedure. In some aspects, the UE may signal one or more alternate paging ranges to be used in a case of a paging failure associated with the preferred paging range. Additionally or alternatively, the UE may signal multiple preferred paging ranges, such as a preferred paging range for each of multiple quality of service indicators and/or a preferred paging range for each of multiple times of day. In some aspects, the UE may identify the preferred paging range using at least one of an artificial intelligence model or machine learning model at the UE.

### FIELD OF THE DISCLOSURE

Aspects of the present disclosure generally relate to wireless communication and specifically relate to techniques, apparatuses, and methods associated with a paging range for a user equipment.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In some examples, a user equipment (UE) may be configured to operate in a reduced-power state, such as a radio resource control (RRC) inactive state and/or an RRC idle state. When the UE is in the RRC idle state, a location granularity of the UE may be a tracking area (TA). In such examples, the TA may be associated with numerous (for example, hundreds) of cells, and each cell may in turn be associated with numerous SSBs. Accordingly, even though the UE may only be located in one cell and one associated SSB (for example, one associated beam) at any given time, the network may be unaware of which cell and/or SSB within a TA contains the idle UE. In that regard, when the network needs to send a paging message to the UE, the network may send a paging message in each cell and/or each SSB associated with a given tracking area code (TAC) to ensure that the UE receives the paging message and transitions to an RRC connected state. Transmitting the paging message via each cell and each associated SSB results in high network energy consumption and high network resource usage.

### SUMMARY

In some aspects, a method of wireless communication performed at a user equipment (UE) includes transmitting a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred synchronization signal blocks (SSBs) associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and receiving a second indication of a paging range, wherein the paging range includes a fifth list of one or more cells to be used for the paging procedure and, for each cell, of the one or more cells, a sixth list of one of more SSBs to be used for the paging procedure.

In some aspects, a method of wireless communication performed at a network node includes receiving, from a UE, a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and transmitting, to the UE, a second indication of a paging range, wherein the paging range includes a fifth list of one or more cells to be used for the paging procedure and, for each cell, of the one or more cells, a sixth list of one of more SSBs to be used for the paging procedure.

In some aspects, an apparatus for wireless communication at a UE includes one or more memories storing processor-executable code; and one or more processors coupled with the one or more memories, at least one processor of the one or more processors configured to cause the UE to: transmit a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and receive a second indication of a paging range, wherein the paging range includes a fifth list of one or more cells to be used for the paging procedure and, for each cell, of the one or more cells, a sixth list of one of more SSBs to be used for the paging procedure.

In some aspects, an apparatus for wireless communication at a network node includes one or more memories storing processor-executable code; and one or more processors coupled with the one or more memories, at least one processor of the one or more processors configured to cause the network node to: receive, from a UE, a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and transmit, to the UE, a second indication of a paging range, wherein the paging range includes a fifth list of one or more cells to be used for the paging procedure and, for each cell, of the one or more cells, a sixth list of one of more SSBs to be used for the paging procedure.

In some aspects, a non-transitory computer-readable medium storing a set of instructions for wireless communication includes one or more instructions that, when executed by one or more processors of a UE, cause the UE to: transmit a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and receive a second indication of a paging range, wherein the paging range includes a fifth list of one or more cells to be used for the paging procedure and, for each cell, of the one or more cells, a sixth list of one of more SSBs to be used for the paging procedure.

In some aspects, a non-transitory computer-readable medium storing a set of instructions for wireless communication includes one or more instructions that, when executed by one or more processors of a network node, cause the network node to: receive, from a UE, a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and transmit, to the UE, a second indication of a paging range, wherein the paging range includes a fifth list of one or more cells to be used for the paging procedure and, for each cell, of the one or more cells, a sixth list of one of more SSBs to be used for the paging procedure.

In some aspects, an apparatus for wireless communication includes means for transmitting a first indication of a first preferred paging range associated with the apparatus and an alternate preferred paging range associated with the apparatus, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and means for receiving a second indication of a paging range, wherein the paging range includes a fifth list of one or more cells to be used for the paging procedure and, for each cell, of the one or more cells, a sixth list of one of more SSBs to be used for the paging procedure.

In some aspects, an apparatus for wireless communication includes means for receiving, from a UE, a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and means for transmitting, to the UE, a second indication of a paging range, wherein the paging range includes a fifth list of one or more cells to be used for the paging procedure and, for each cell, of the one or more cells, a sixth list of one of more SSBs to be used for the paging procedure.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment (UE) in a wireless network.

FIG. 3 is an example state machine diagram 300 illustrating states of a radio resource control (RRC) procedure and transitions between the states.

FIG. 4 is a diagram of an example associated with a paging range for a UE.

FIG. 5 is a flowchart illustrating an example process performed, for example, at a UE or an apparatus of an UE to receive a paging message while in an RRC idle state.

FIG. 6 is a flowchart illustrating an example process performed, for example, at a network node or an apparatus of a network node to page a UE using a finer granularity than a tracking area.

FIG. 7 is a diagram of an example apparatus for wireless communication that supports a paging range for a UE.

FIG. 8 is a diagram of an example apparatus for wireless communication that supports a paging a UE at a paging range granularity.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a user equipment (UE) may be configured to operate in a reduced-power state, such as a radio resource control (RRC) inactive state and/or an RRC idle state. When the UE is in the RRC idle state, a location granularity of the UE may be a tracking area (TA), which, in some examples, may be associated with a tracking area code (TAC). For example, while in the RRC idle state, a UE may collect system information (SI) from cells as the UE moves between the cells. The UE may notify the network of a TAC associated with a TA including a first cell in which the UE is located, and as the UE moves from cell to cell, the UE may update its location with the network if a corresponding TA changes (for example, if a TAC associated with a new cell is the same as a TAC associated with a previous cell, the UE may perform no registration procedure with the network, but, if a TAC associated with a new cell is different from a TAC associated with a previous cell, the UE may perform a registration procedure with the network). In such examples, the TA may be associated with numerous (for example, hundreds) of cells, and each cell may in turn be associated with numerous synchronization signal blocks (SSBs). Accordingly, even though the UE may only be located in one cell and one associated SSB (for example, one associated beam) at any given time, the network may be unaware of which cell and/or SSB within a TA contains the idle UE. In that regard, when the network needs to send a paging message to the UE, the network may send a paging message in each cell and/or in each SSB associated with a given TAC to ensure that the UE receives the paging message and transitions to the RRC connected state. Transmitting the paging message via each cell and/or each associated SSB results in high network energy consumption and high network resource usage.

Various aspects relate generally to configuration of a UE with a paging range for a paging procedure. Some aspects more specifically relate to configuring a UE with a paging range that includes fewer than all cells associated with a TA and/or fewer than all SSBs associated with a TA. In some aspects, a UE may signal a preferred paging range for a paging procedure (for example, a list of preferred cells and/or associated SSBs) to a network entity (for example, a core network (CN) entity, such as an access and mobility management function (AMF) entity, and the network entity may configure the UE with a paging range for the paging procedure (for example, a configured list of cells and/or associated SSBs to be used for the paging procedure). In some aspects, the UE may signal one or more alternate paging ranges to be used in a case of a paging failure associated with the preferred paging range. Additionally, or alternatively, the UE may signal multiple preferred paging ranges, such as a preferred paging range for each of multiple quality of service (QoS) indicators and/or a preferred paging range for each of multiple times of day. In some aspects, the UE may identify the preferred paging range using at least one of an artificial intelligence (AI) model or machine learning (ML) model at the UE, and/or the network entity may identify the configured paging range using at least one of an AI model or ML model at the network.

Particular aspects of the subject matter described in this disclosure can be implemented to realize one or more of the following potential advantages. In some examples, by configuring a UE with a paging range, the described techniques can be used to page a UE (for example, when the UE is in an RRC idle state) using fewer than all cells associated with a TA and/or fewer than all SSBs associated with a TA, resulting in reduced power consumption at the network and/or reduced consumption of network resources. Moreover, by the UE signaling the preferred paging range for a paging procedure to the network entity and the network entity in turn configuring the UE with the paging range for the paging procedure using the preferred paging range, the described techniques can be used to identify a paging range using increased transparency and/or to configure the UE with an optimal list of cells and/or SSBs for a paging procedure, thereby resulting in improved paging operations and thus reduced power, network, and computing resource consumption otherwise associated with suboptimal paging operations.

Additionally, by configuring the UE with one or more alternate paging ranges to be used in a case of a paging failure, the described techniques can be used to successfully and timely complete a paging procedure even in instances in which the UE has left the paging range, thereby improving paging operations associated with the UE. Furthermore, by configuring the UE with multiple paging ranges, such as a paging range for each of multiple QoS indicators and/or times of day, the described techniques can be used to provide the UE with certain high-priority communications (for example, voice traffic) with minimal latency while enabling power and other resource conservation for other, low-priority communications (for example, background data). Moreover, by using an AI/ML model at the UE to identify the preferred paging range and/or by using an AI/ML mode at the network entity to identify the paging range, the described techniques can be used to continuously improve and/or optimize paging ranges, thereby reducing power consumption and latency associated with paging operations.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or AI/ML, among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

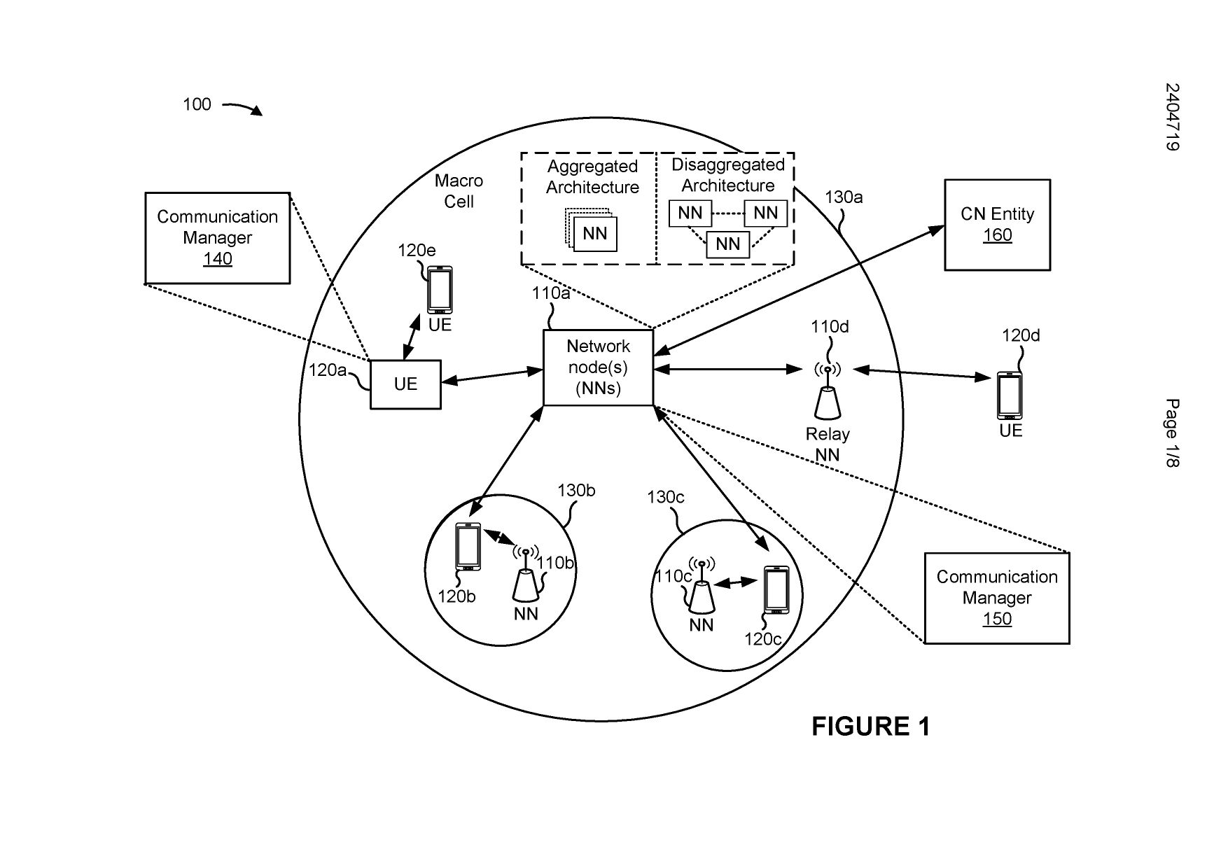

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network (e.g., CN entity 160) of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c.Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication.

In some aspects, the UE 120 may include a communication manager 140. As described in more detail elsewhere herein, the communication manager 140 may transmit a first indication of a first preferred paging range associated with the UE 120 and an alternate preferred paging range associated with the UE 120, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and receive a second indication of a paging range, wherein the paging range includes a fifth list of one or more cells to be used for the paging procedure and, for each cell, of the one or more cells, a sixth list of one of more SSBs to be used for the paging procedure. Additionally, or alternatively, the communication manager 140 may perform one or more other operations described herein.

In some aspects, the network node 110 may include a communication manager 150. As described in more detail elsewhere herein, the communication manager 150 may receive, from a UE, a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and transmit, to the UE, a second indication of a paging range, wherein the paging range includes a fifth list of one or more cells to be used for the paging procedure and, for each cell, of the one or more cells, a sixth list of one of more SSBs to be used for the paging procedure. Additionally, or alternatively, the communication manager 150 may perform one or more other operations described herein.

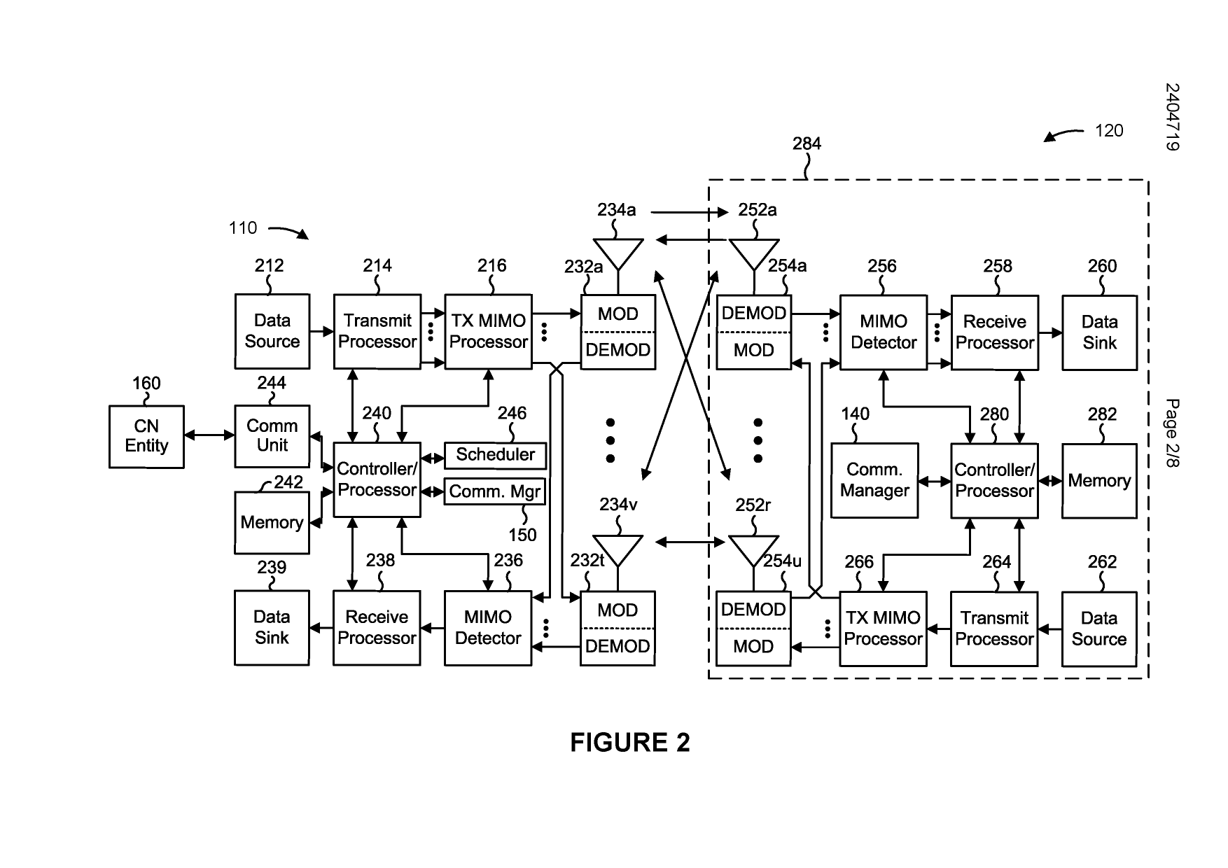

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t ≥ 1), a set of antennas 234 (shown as 234a through 234v, where v ≥ 1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” or “a/the controller/processor” (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use downlink control information (DCI) to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network (e.g., CN entity 160) and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r ≥ 1), a set of modems 254 (shown as modems 254a through 254u, where u ≥ 1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may identify, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include an uplink control information (UCI) communication, a medium access control (MAC) control element (MAC-CE) communication, an RRC communication, or another type of uplink communication. Uplink signals may be transmitted on a physical uplink scheduled channel (PUSCH), a physical uplink control channel (PUCCH), and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

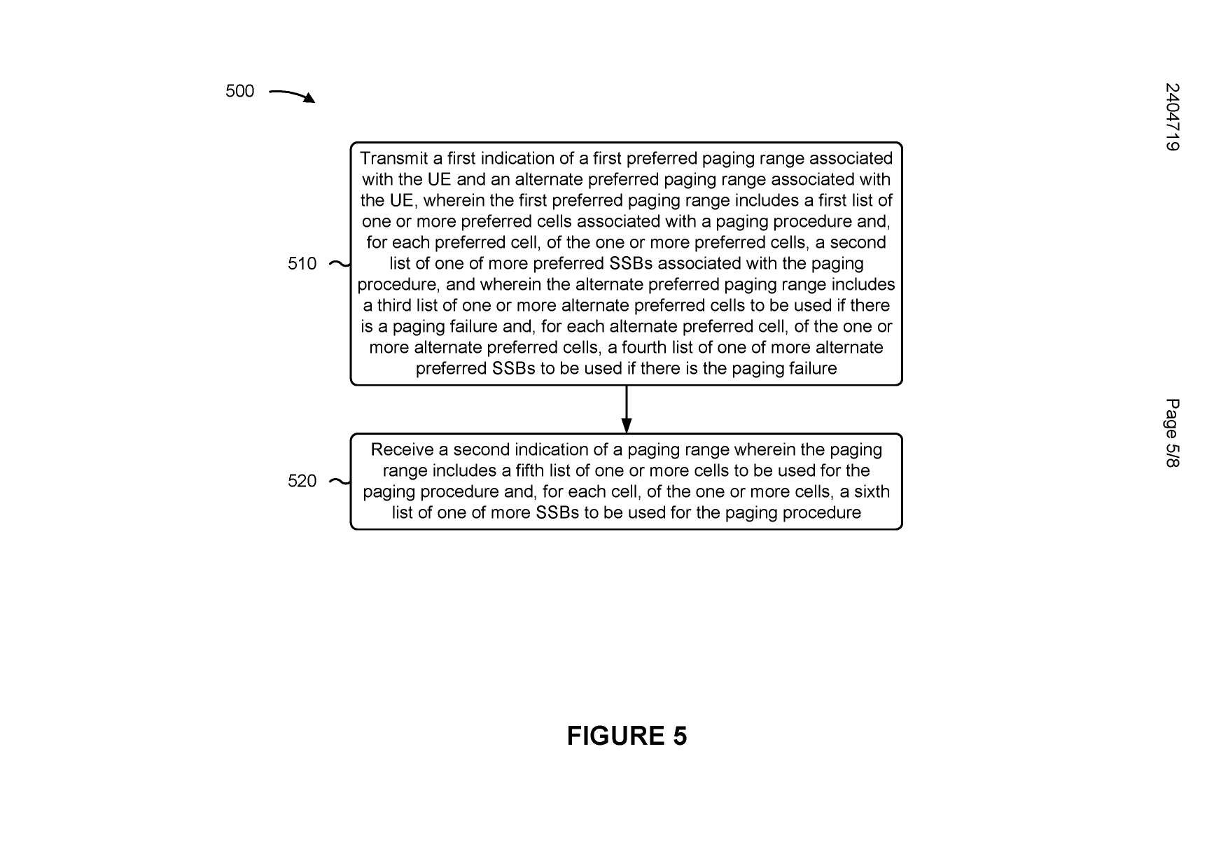

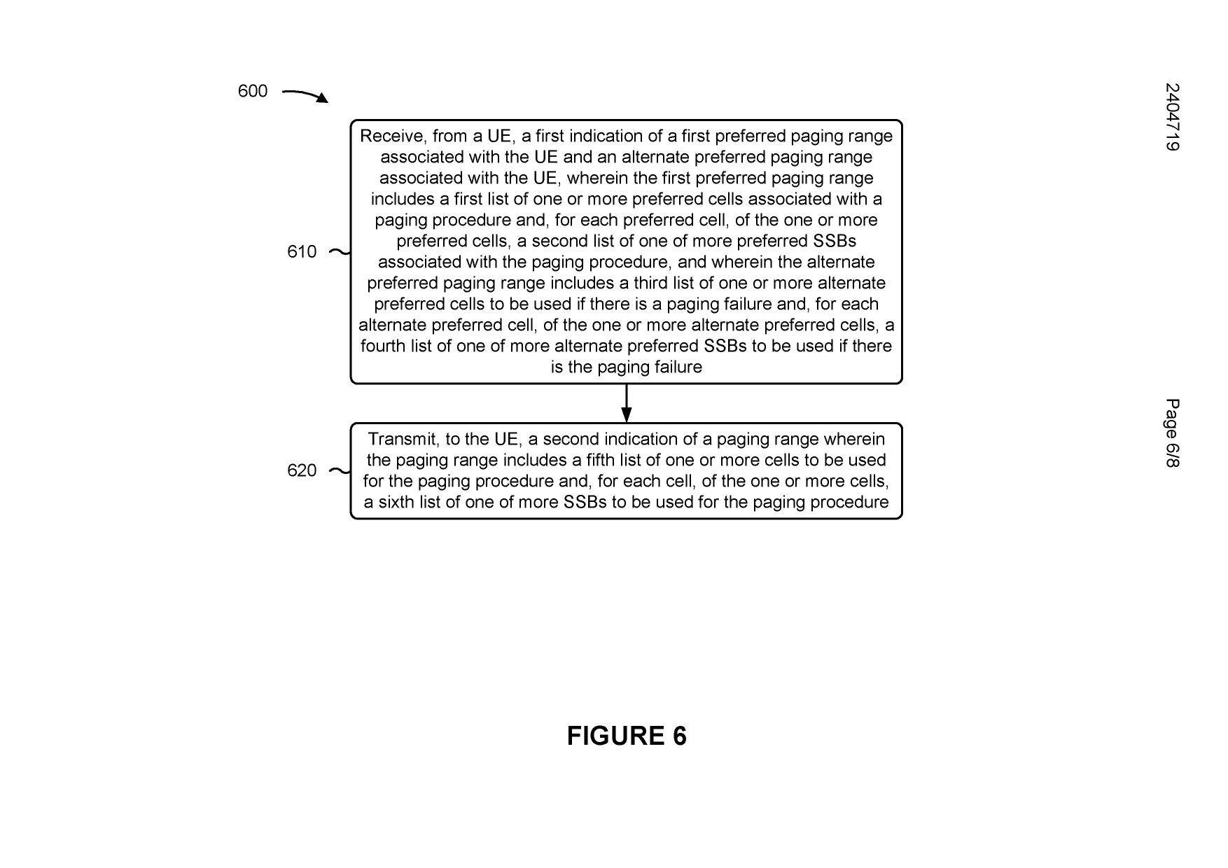

The network node 110, the controller/processor 240 of the network node 110, the UE 120, the controller/processor 280 of the UE 120, a CU, a DU, an RU, or any other component(s) of FIGS. 1 or 2 may implement one or more techniques or perform one or more operations associated with a paging range for a UE, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 500 of FIG. 5, process 600 of FIG. 6, or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

In some aspects, the UE 120 includes means for transmitting a first indication of a first preferred paging range associated with the UE 120 and an alternate preferred paging range associated with the UE 120, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and/or means for receiving a second indication of a paging range, wherein the paging range includes a fifth list of one or more cells to be used for the paging procedure and, for each cell, of the one or more cells, a sixth list of one of more SSBs to be used for the paging procedure. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a UE, a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and/or means for transmitting, to the UE, a second indication of a paging range, wherein the paging range includes a fifth list of one or more cells to be used for the paging procedure and, for each cell, of the one or more cells, a sixth list of one of more SSBs to be used for the paging procedure. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

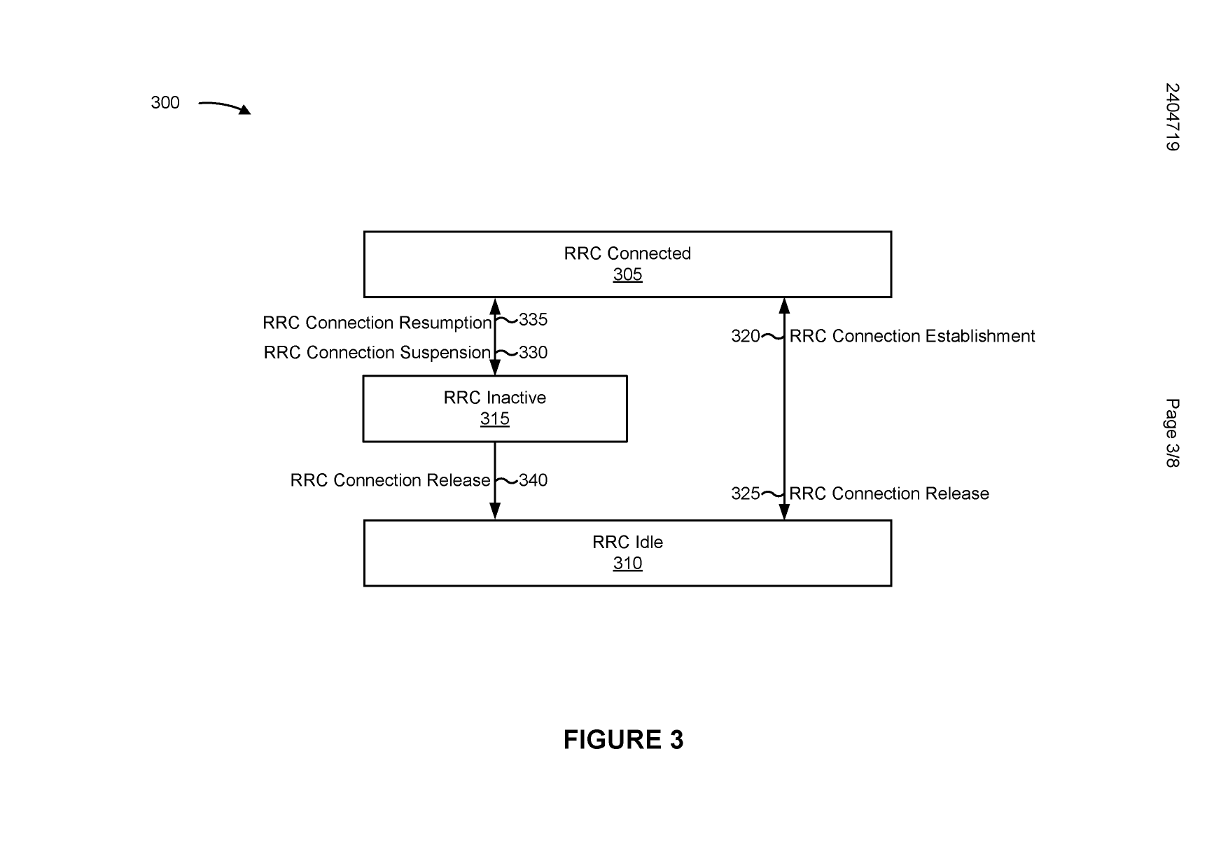

In some examples, a UE 120 may be configured to enter a low-power state, such as during periods of reduced communication activity at the UE 120. For example, FIG. 3 is an example state machine diagram 300 illustrating states of an RRC procedure and transitions between the states in accordance with various aspects of the present disclosure. As shown, a UE may transition among an RRC connected state 305, an RRC idle state 310, and an RRC inactive state 315. An RRC procedure may be used, for example, for connection establishment, re-establishment, or release between a UE and a network node, for on-demand transfer of system information, for suspension or resumption of an RRC connection, for signaling relating to handover, or for radio link handling, among other examples.

Upon powering on, a UE may enter the RRC idle state 310. The UE may transition from the RRC idle state 310 to the RRC connected state 305 via RRC connection establishment 320 (sometimes referred to as attaching to the network). The UE may transition from the RRC connected state 305 to the RRC idle state 310 via RRC connection release 325 (sometimes referred to as detaching from the network) or due to a connection failure. Alternatively, the UE may transition from the RRC connected state 305 to the RRC inactive state 315 via RRC connection suspension 330 (also referred to as RRC suspend or RRC release with suspend). In the RRC inactive state, the UE maintains the RRC connection while reducing signaling and power consumption. In the RRC inactive state 315, the UE may transition to the RRC connected state 305 via RRC connection resumption 335 (also referred to as RRC resume), or may transition to the RRC idle state 310 via RRC connection release 340 or due to a connection failure. In the RRC connected state 305 and the RRC inactive state 315, the UE is registered with and connected to the core network (e.g., connected to the CN entity 160). In the RRC idle state 310, the UE is de-registered from the core network.

In the RRC connected state 305, a core network to RAN connection may be established for the UE for both the user plane and the control plane, the UE may be capable of communicating using the RAN connection (for example, a network node connection) and the core network, the UE and the RAN may store an access stratum context for the UE, the RAN may store information indicating the cell that is serving the UE, unicast data may be transferred between the RAN and the UE, the network may control mobility of the UE (including, for example, UE measurements), and the UE may be capable of operating in a connected mode discontinuous reception (CDRX) mode for power saving.

In the RRC idle state 310, the UE may be capable of selecting a public land mobile network (PLMN), receiving system information messages, having mobility for cell re-selection, receiving pages initiated and managed by the core network, and operating in a discontinuous reception (DRX) mode for power saving.

In the RRC inactive state 315, the UE may be capable of receiving system information messages, having mobility for cell re-selection, receiving pages initiated and managed by the RAN, and operating in a DRX mode for power saving. Furthermore, an RRC connection between the UE and the RAN (and the RAN and the core network) remains established for the UE, the UE continues to store an access stratum context for the UE, and the RAN may continue to store information indicating the cell that is serving the UE. Because both the UE and the network node store an access stratum context for the UE in the RRC inactive state 315, transitioning from the RRC inactive state 315 to the RRC connected state 305 does not require non-access stratum (NAS) signaling, which extends UE battery life and reduces latency in transitioning to the RRC connected state 305 as compared to transitioning from the RRC idle state 310 to the RRC connected state 305. In some aspects, the UE may transition from the RRC connected state 305 to the RRC inactive state 315 due to lack of activity (for example, based at least in part on a timer).

In some examples, such as in examples in which a UE is in the RRC idle state 310, a location granularity of the UE may be a TA, which, in some examples, may be associated with a TAC. For example, while in the RRC idle state 310, a UE may collect SI from cells as the UE moves between the cells. The UE may notify the network of a TAC associated with a TA including a first cell in which the UE is located, and as the UE moves from cell to cell, the UE may update its location with the network if a corresponding TA changes (for example, if a TAC associated with a new cell is the same as a TAC associated with a previous cell, the UE may perform no registration procedure with the network, but, if a TAC associated with a new cell is different from a TAC associated with a previous cell, the UE may perform a registration procedure to update the UE’s location with the network). In such examples, the TA may be associated with numerous (for example, hundreds) of cells, and each cell may in turn be associated with numerous SSBs. Accordingly, even though the UE may only be located in one cell and one associated SSB (for example, one associated beam) at any given time, the network may be unaware of which cell and/or SSB within a TA contains the idle UE. In that regard, when the network needs to send a paging message to the UE, the network may send a paging message in each cell and/or each SSB associated with a given TAC to ensure that the UE receives the paging message and transitions to the RRC connected state 305. Transmitting the paging message via each cell and each associated SSB results in high network energy consumption and high network resource usage.

Some techniques described herein enable improved paging mechanisms for a UE, such as a UE that is in an RRC idle state. In some aspects, a UE may signal a preferred paging range for a paging procedure (for example, a list of preferred cells and/or associated SSBs) to a network entity (for example, a core network entity, such as an AMF entity), and the network entity may configure the UE with a paging range for the paging procedure (for example, a configured list of cells and/or associated SSBs to be used for the paging procedure). In some aspects, the UE may signal one or more alternate paging ranges to be used in a case of a paging failure associated with the preferred paging range. Additionally or alternatively, the UE may signal multiple preferred paging ranges, such as a preferred paging range for each of multiple QoS indicators and/or a preferred paging range for each of multiple times of day. In some aspects, the UE may identify the preferred paging range using at least one of an AI model or ML model at the UE, and/or the network entity may identify the configured paging range using at least one of an AI model or ML model at the network. In this way, the network may page the UE using fewer than all cells and/or SSBs associated with a TA, resulting in optimized paging operations and thus reduced power, computing, and network resource consumption.

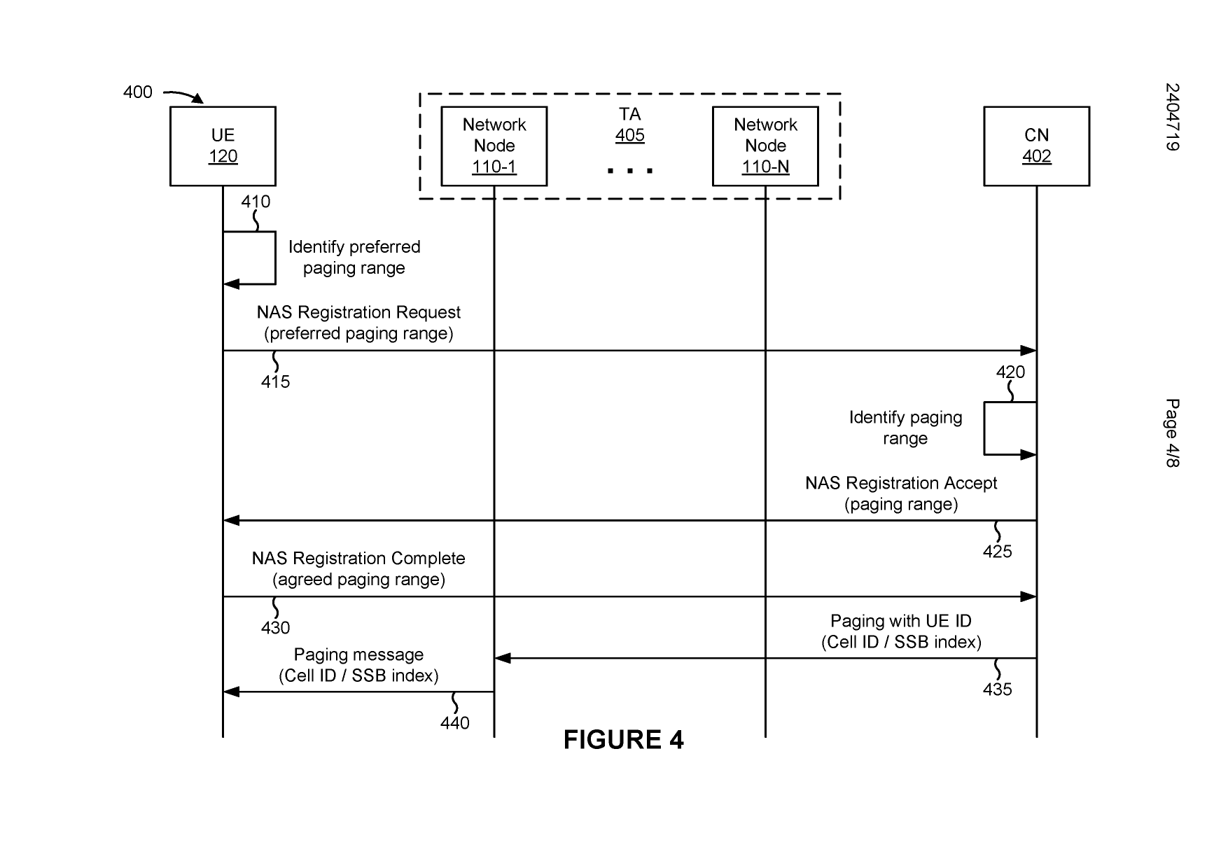

FIG. 4 is a diagram of an example 400 associated with a paging range for a UE, in accordance with the present disclosure. As shown in FIG. 4, a UE 120 may communicate with a CN entity 402 (e.g., CN entity 160) via one or more network nodes 110 (shown in FIG. 4 as a first network node 110-1 through an N^{th} network node 110-N). In some aspects, the UE 120 and the network nodes 110 may be part of a wireless network (for example, wireless communication network 100). The UE 120 and the network nodes 110 may have established a wireless connection prior to operations shown in FIG. 4. In some aspects, the network nodes 110 (e.g., network nodes 110-1 to 110-N) may belong to a same TA 405 and/or may be associated with a same TAC. In such aspects, when the UE 120 enters an RRC idle state (for example, RRC idle state 310), the network (for example, the CN entity 402) may be informed of the UE 120’s location at a TA granularity, as described above in connection with FIG. 3. In some aspects, the CN entity 402, which may correspond to the CN entity 160 described above in connection with FIGS. 1 and 2, may be associated with an AMF entity of a CN (for example, a 5G CN, a 6G CN, or a similar CN), among other examples.

In a first operation 410, the UE 120 may identify a preferred paging range to be used for a paging procedure (for example, to be used to transmit a paging message to the UE 120, such as when the UE 120 is in an RRC idle state), and/or, in a second operation 415, the UE 120 may signal the preferred paging range to the CN entity 402 (for example, via one or more of the network nodes 110). As used herein, “paging range” refers to a list of cells that may be used to page the UE 120 and a list of associated SSBs (for example, beams) for each cell that may be used to page the UE 120. In that regard, the preferred paging range may include a list of one or more preferred cells associated with the paging procedure (for example, one or more cells associated with one or more of the first network node 110-1 through the N^{th} network node 110-N and/or one or more network nodes 110 associated with one or more other TAs (e.g., one or more TAs different from TA 405) and/or one or more other TACs (e.g., one or more TACs different from a TAC associated with the TA 405)) and, for each preferred cell, a list of one of more preferred SSBs associated with the paging procedure. In that regard, in some aspects the preferred paging range may include cells only within a given TA (e.g., TA 405) and/or associated with a given TAC, while, in some other aspects, the preferred paging range may include cells spanning multiple TAs and/or associated with multiple TACs. In some aspects, the preferred paging range may include fewer than all cells within the TA 405 and/or fewer than all SSBs associated with each preferred cell. In this regard, when the UE 120 is to be paged by the network (for example, by the CN entity 402, which is described in more detail below), the network make conserve power and/or network resources that would have otherwise been consumed by paging the UE 120 using all cells and/or SSBs associated with the TA 405.

In some aspects, the UE 120 may signal the preferred paging range to the CN entity 402 via a registration procedure. In that regard, in the second operation 415, the UE 120 may transmit, and the CN entity 402 may receive (for example, via one of the network nodes 110 associated with the TA 405) the indication of the preferred paging range via an NAS registration request message. Additionally or alternatively, the preferred paging range may indicate, for each preferred cell, a global unique cell identifier (ID) for that preferred cell, and/or for each SSB, an SSB beam ID, among other examples. In some other aspects, the UE 120 may signal the preferred paging range to the CN entity 402 using an NAS message different from an NAS registration request message. For example, the NAS message may be an existing NAS message specified by a wireless communication standard (e.g., a wireless communication standard promulgated by the 3GPP) in which the preferred paging range is indicated using an information element (IE) associated with the preferred paging range (e.g., an IE specifically used for signaling one or more preferred paging ranges to the CN entity 402), or else may be a new NAS message (e.g., an NAS message specifically used for signaling one or more preferred paging ranges to the CN entity 402).

In some aspects, the UE 120 may identify and/or signal multiple preferred paging ranges. For example, the UE 120 may identify a corresponding preferred paging range for each of multiple QoS indicators, such as multiple 5G QoS indicators (5QIs). Put another way, preferred paging ranges identified and/or signaled by the UE 120 may be QoS dependent, network slice dependent, and/or application dependent, among other examples. In that way, the UE 120 may identify a first preferred paging range associated with a first QoS indicator (for example, a first 5QI), a second preferred paging range associated with a second QoS indicator (for example, a second 5QI), and so forth. For example, a preferred paging range associated with a relatively high-priority QoS indicator, such as a QoS indicator associated with voice traffic, may include numerous cells and/or SSBs, such as for a purpose of ensuring a paging message associated with the high-priority traffic reaches the UE with minimal latency. However, a preferred paging range associated with a relatively low-priority QoS indicator, such as a QoS indicator associated with background data traffic, may include relatively few cells and/or SSBs, such as for a purpose of enabling maximum network energy savings by minimizing a quantity of paging messages transmitted over the network.

Additionally or alternatively, the UE 120 may identify a corresponding preferred paging range for each of multiple times of day. In that way, the UE 120 may identify a first preferred paging range associated with a first time of day (for example, morning), a second preferred paging range associated with a second time of day (for example, afternoon), and so forth. For example, a location of the UE 120 may be time-dependent. In a morning time period, the UE 120 may be relatively stationary and in a first location (for example, a home), in a mid-morning time period the UE 120 may be relatively mobile (for example, corresponding to a morning commute), in a mid-day period the UE 120 may relatively stationary and in a second location (for example, an office), in an early evening time period the UE 120 may be relatively mobile (for example, corresponding to an evening commute), and/or in an evening and/or nighttime time period the UE 120 may be relatively stationary and again be in the first location (for example, the home). Accordingly, the UE may identify and/or signal multiple time-dependent preferred paging ranges, such that if the network (for example, the CN entity 402) needs to page the UE 120 at a given time of day, the network may use the preferred paging range that corresponds to the specific time of day that the paging message is to be sent.

In some aspects, the UE 120 may identify and/or signal a list of cells and/or corresponding SSBs to be used in a case of a paging failure, which is sometimes referred to herein an alternative preferred paging range. Put another way, in connection with the first operation 410, the UE 120 may identify one or more alternate preferred paging ranges, and/or in connection with the second operation 415, the UE 120 may transmit an indication of the one or more alternate preferred paging ranges to the CN entity 402 (for example, via one or more network nodes 110). The alternate preferred paging range may include a list of one or more alternate preferred cells to be used if there is a paging failure (for example, if the UE 120 cannot be reached using the preferred paging range) and/or, for each alternate preferred cell, a list of one of more alternate preferred SSBs to be used if there is the paging failure.

For example, the UE 120 may identify and/or signal a preferred paging range, which may include a relatively narrow list of cells and/or SSBs in which to transmit a paging message. The UE 120 may further identify a first alternate preferred paging range, a second alternate preferred paging range, and so forth, which may include an increasing quantity of cells and/or SSBs to be used to attempt to reach the UE 120 when there is a paging failure associated with the preferred paging range (for example, when the UE 120 does not respond to the paging message within a certain threshold). For example, a first alternate preferred paging range may include less than all cells with the TA 405 and/or less than all SSBs for each identified cell, but may nonetheless include more cells and/or SSBs than the preferred paging range, and/or a second alternative preferred paging range may include all cells and/or associated SSBs for the TA 405. In this regard, when there is a paging message to be transmitted to the UE 120 for a given QoS indicator and/or time of day, the network may first page the UE 120 using the preferred paging range (for example, a relatively narrow list of cells and/or SSBs). If there is a paging failure using the preferred paging range (for example, if the UE 120 does not respond to the paging message within a certain time threshold), the network may next page the UE 120 using the first alternate preferred paging range (for example, a broader list of cells and/or SSBs). Similarly, if there is a paging failure using the first alternate preferred paging range (for example, if the UE 120 does not respond to the paging message within a certain time threshold), the network may next page the UE 120 using the second alternate preferred paging range (for example, all the cells and/or SSBs in the TA 405).

In some aspects, the UE 120 may identify and/or signal a time window in which there is no preferred paging range associated with the UE 120. Put another way, the UE 120 may identify and/or signal to the network (for example, the CN entity 402) a time range during which there are no preferred cells associated with the paging procedure. For example, if during a certain time of day the UE 120 is not typically located in any one cell and/or SSB, such as a time of day in which the UE 120 is relatively mobile (for example, a time of day that the UE 120 is typically commuting and/or a weekend day or other day that is not associated with a set schedule, among other examples), the UE 120 may indicate that, if a paging message is to be transmitted during that time period, there is no preferred paging range associated with the UE 120. Accordingly, if the network needs to page the UE 120 during such a time period, the network may simply page the UE 120 using all cells and/or SSBs within the TA 405.

In some aspects, the UE 120 may identify the preferred paging range and/or any alternate preferred paging ranges using an AI model and/or a ML model (for example, an AI/ML model) associated with the UE 120 (for example, that is located within the UE 120). For example, in connection with the first operation 410, an AI/ML model within the UE 120 may identify the one or more preferred paging ranges, any alternate paging ranges, and/or any time periods for which there is no preferred paging range, such as by using historical data associated with UE 120, calendar and/or scheduling information associated with the UE 120, and/or similar data. For example, an AI/ML model may predict that a UE 120 will likely be in a first location and/or within a first cell/SSB at a first time of day, a second location and/or within a second cell/SSB at second time of day, and/or relatively mobile and thus not within any given cell/SSB at a third time of day, using past trends, scheduling information (for example, calendar information), and/or similar data, and thus the AI/ML model may identify the preferred paging ranges and/or alternate paging ranges, accordingly.

As described above in connection with the second operation 415, in some aspects the UE 120 may signal the preferred paging range as part of a registration procedure associated with the network, such as by signaling the preferred paging range via an NAS registration request message, among other examples. In such aspects, the NAS registration request message including the indication of the preferred paging range may be triggered based on preferred paging range changes at a cell level and/or an SSB level (for example, a beam level), based on a change to a TA (for example, TA 405) associated with the UE 120, and/or based on a timer, among other examples. For example, when the UE 120 enters a new TA (for example, TA 405), the UE 120 may trigger the registration procedure and/or transmit an indication of a preferred paging associated with the new TA, accordingly. Moreover, when the UE 120 is within a given TA for a certain time threshold, the UE 120 may again trigger the registration procedure and thus may transmit the indication of the preferred paging range at that time. Moreover, while in the TA 405, if the UE 120 makes changes to the preferred paging range (for example, at a cell and/or SSB level), the UE 120 may trigger the registration procedure in order to provide an updated preferred paging range to the network (for example, the CN entity 402).

In a third operation 420, using the preferred paging range received from the UE 120 and/or other information, such as network energy savings (NES) parameters, QoS requirements, and/or similar information, the network (for example, the CN entity 402) may identify a paging range to be used for a paging procedure (for example, the CN entity 402 may identify a list of one or more cells to be used for the paging procedure and, for each cell, a list of one of more SSBs to be used for the paging procedure). In some aspects, the paging range identified by the CN entity 402 may be the same paging range as the preferred paging range indicated to the CN entity 402 by the UE 120 (for example, via the NAS registration request message described above in connection with the second operation 415), while, in some other aspects, the paging range identified by the CN entity 402 may be a different paging range than the preferred paging range indicated to the CN entity 402 by the UE 120.

For example, in aspects in which the preferred paging range aligns with NES requirements, QoS parameters, and/or similar data-handling parameters, the CN entity 402 may adopt the preferred paging range indicated by the UE 120. However, in aspects in which the preferred paging range does not align with NES requirements, QoS parameters, and/or similar data-handling parameters, the CN entity 402 may utilize a different paging range than the preferred paging range indicated by the UE 120. For example, if the preferred paging range indicates too many cells and/or SSBs, such that the network is unable to meet target NES requirements, the paging range may include fewer cells and/or fewer SSBs than the quantity of cells and/or SSBs indicated by the UE 120, such as for a purpose of reducing power consumption at the network level. On the other hand, if the preferred paging range indicates fewer cells and/or SSBs than permitted to meet NES requirements, the paging range may include more cells and/or more SSBs than the quantity of cells and/or SSBs indicated by the UE 120, such as for a purpose of reducing latency associated with a paging procedure associated with the UE 120.

Moreover, in some aspects the CN entity 402 may identify multiple paging ranges, such as multiple QoS-dependent paging ranges, multiple time-of-day-dependent paging ranges, one or more alternate paging ranges (for example, one or more paging ranges to be used in a case of a paging failure), and/or time periods during which no paging range applies (for example, time periods in which the UE 120 is to be paged using all cells and/or SSBs within the TA 405). Additionally or alternatively, the network may identify the paging range using at least one of an AI model or an ML model associated with the CN (for example, an AI/ML model located at the CN entity 402). For example, the CN entity 402 may identify the paging range using an AI/ML model that uses power consumption trends, traffic data, and/or similar information as inputs in order to optimize paging procedures at one or more UEs while meeting certain NES thresholds, among other examples.

In a fourth operation 425, the CN entity 402 may transmit, and the UE 120 may receive (for example, via one or more of the network nodes 110), an indication of the paging range. Put another way, based on receiving the indication of the preferred paging range from the UE 120, the CN entity 402 may enable the paging range and/or may configure the UE 120 to utilize the paging range for a paging procedure. Additionally or alternatively, in aspects in which the UE 120 signals the preferred paging range to the network during a registration procedure (for example, using the NAS registration request message, as described above in connection with the second operation 415), the CN entity 402 may signal the paging range to the UE 120 during the registration procedure, such as via an NAS registration accept message. In some other aspects, the CN entity 402 may signal the paging range to the UE 120 using an NAS message different from an NAS registration accept message. For example, the NAS message may be an existing NAS message specified by a wireless communication standard (e.g., a wireless communication standard promulgated by the 3GPP) in which the paging range is indicated using an IE associated with the paging range (e.g., an IE specifically used for signaling one or more paging ranges to the UE 120), or else may be a new NAS message (e.g., an NAS message specifically used for signaling one or more paging ranges to the UE 120).

Moreover, in some aspects, in CN entity 402 (for example, an AMF entity) may request that the UE 120 report the updated and/or agreed paging range to the network, such as via an NAS registration complete message. In such aspects, in a fifth operation 430, the UE 120 may transmit, and the CN entity 402 may receive (for example, via one or more of the network nodes 110), an indication of an updated and/or agreed paging range associated with the UE 120, which, in some aspects, may be transmitted via an NAS registration complete message. In some other aspects, the UE 120 may signal the updated and/or agreed paging range to the CN entity 402 using an NAS message different from an NAS registration complete message. For example, the NAS message may be an existing NAS message specified by a wireless communication standard (e.g., a wireless communication standard promulgated by the 3GPP) in which the agreed paging range is indicated using an IE associated with the agreed paging range (e.g., an IE specifically used for signaling one or more agreed paging ranges to the CN entity 402), or else may be a new NAS message (e.g., an NAS message specifically used for signaling one or more agreed paging ranges to the CN 402).

In some aspects, the agreed paging range may include a list of one or more cells agreed to by the UE 120 and the CN entity 402 for the paging procedure, and, for each cell agreed to by the UE 120 and the CN entity 402, a list of one of more SSBs agreed to by the UE 120 and the CN entity 402 for the paging procedure. Moreover, the indication of the updated and/or agreed paging range associated with the UE 120 may correspond to the paging range signaled to the UE 120 via the indication described above in connection with the fourth operation 425 (for example, the paging range signaled to the UE 120 via the NAS registration accept message), which, as described above, may or may not be the same as the preferred paging range signaled to the network as described above in connection with the second operation 415. Put another way, the indication of the updated and/or agreed paging range may include the list of one or more cells to be used for the paging procedure that was indicated via the signaling described above in connection with the fourth operation 425 (for example, the NAS registration accept message) and, for each cell, the list of one of more SSBs to be used for the paging procedure that was indicated via the signaling described above in connection with the fourth operation 425.

In this regard, when the UE 120 is to be paged by the network, the network may transmit a paging message using fewer than all of the cells and/or SSBs within the TA 405, such as by transmitting a paging message via the cells and/or SSBs associated with the paging range described above in connection with the third operation 420 and the fourth operation 425. More particularly, when the CN entity 402 (for example, an AMF entity) receives a downlink data notification associated with the UE 120 and/or identifies that the UE 120 is in an RRC idle mode, the CN entity 402 may send paging to a list of cells and/or SSBs associated with the paging range. More particularly, in a sixth operation 435, when a paging message is to be transmitted to the UE 120, the CN entity 402 may transmit a paging indication to one or more network nodes 110 (for example, the first network node 110-1) in the TA 405 that are associated with one or more cells of the paging range. The indication may indicate an ID associated with the UE 120, one or more cell IDs to be used for the paging procedure, and/or, for each cell ID, one or more SSB beam IDs to be used for the paging procedure.

In response, in a seventh operation 440, the network node 110 may transmit, and the UE 120 may receive, a paging message. The network node 110 may transmit the paging message using only the cell IDs and/or SSB IDs indicated by the CN entity 402, which, as described above, may correspond to the agreed paging range between the UE 120 and the CN entity 402. Put another way, the network node 110 (for example, the first network node 110-1 in the example shown in FIG. 4) may transmit, and the UE 120 may receive, a paging message associated with the paging procedure via at least one cell and at least one SSB associated with the paging range. Moreover, in aspects in which the UE 120 indicated one or more alternate preferred paging ranges and/or in which the CN entity 402 configured the UE 120 with one or more alternate paging ranges, one or more network nodes 110 may page the UE 120 using the one or more alternate paging ranges when there is a paging failure using the paging range (for example, when the UE 120 cannot be reached using the paging range within a certain time threshold). For example, in a case of a paging failure, such as when the UE 120 does not receive a paging message and/or does not respond to a paging message prior to expiration of a timer and/or within a certain threshold, the CN entity 402 may trigger transmission of a paging message to an expanded list of cells and/or SSBs associated with the one or more alternate paging ranges.

Based at least in part on the UE 120 and the network utilizing a paging range for a paging procedure, the UE 120 and/or the network may conserve computing, power, network, and/or communication resources that may have otherwise been consumed traditional paging procedures. For example, based at least in part on the UE 120 and the network utilizing a paging range for a paging procedure that is associated with fewer than all cells of a TA or fewer than all SSBs of a TA, the network may trigger paging on less than all cells and/or SSBs within a TA, thereby conserving computing, power, network, and/or communication resources that may have otherwise been consumed by paging the UE 120 using all cells and/or SSBs within a TA.

FIG. 5 is a flowchart illustrating an example process 500 performed, for example, at a UE or an apparatus of an UE that supports a paging range for the UE in accordance with the present disclosure. Example process 500 is an example where the apparatus or the UE (for example, UE 120) performs operations associated with receiving a paging message that is transmitted using fewer than all cells and/or SSBs associated with a TA.

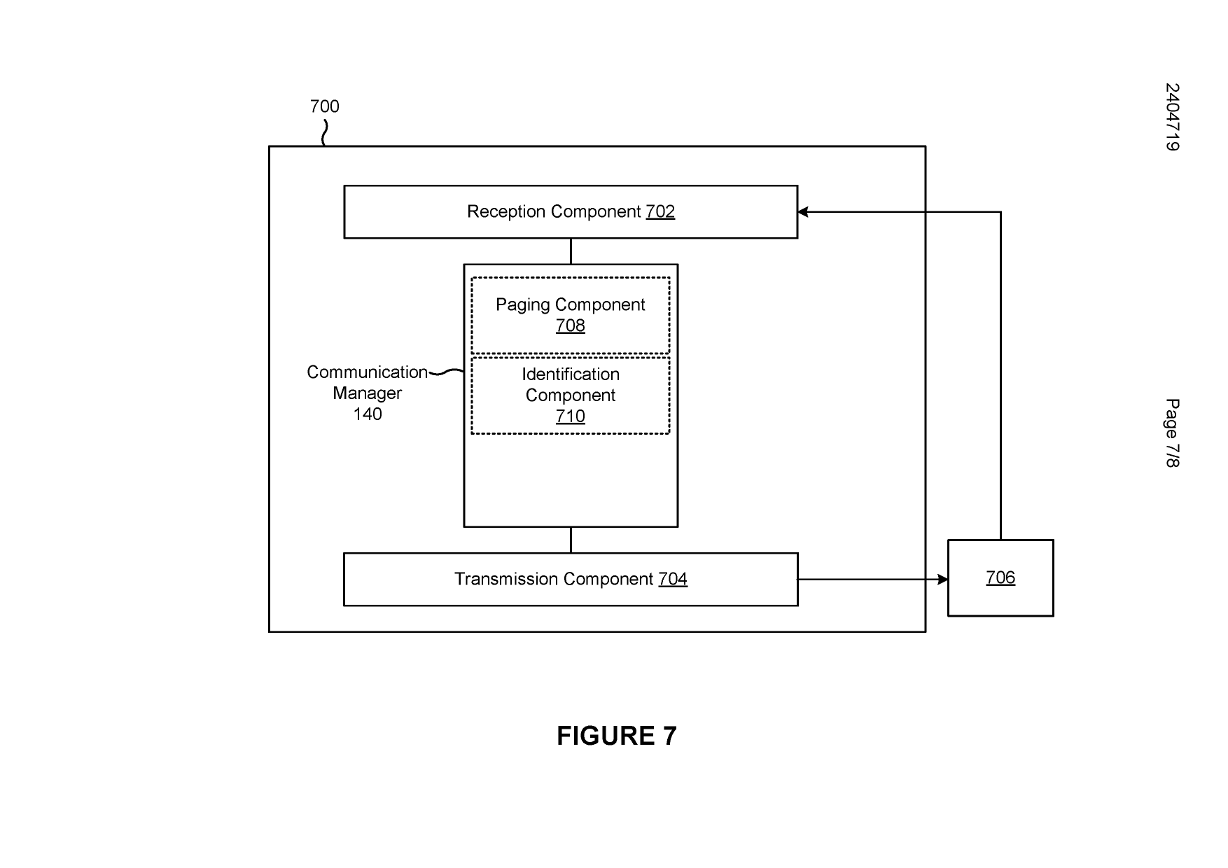

As shown in FIG. 5, in some aspects, process 500 may include transmitting a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure (block 510). For example, the UE (such as by using communication manager 140, transmission component 704, and/or paging component 708, depicted in FIG. 7) may transmit a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure, as described above.

As further shown in FIG. 5, in some aspects, process 500 may include receiving a second indication of a paging range, wherein the paging range includes a fifth list of one or more cells to be used for the paging procedure and, for each cell, of the one or more cells, a sixth list of one of more SSBs to be used for the paging procedure (block 520). For example, the UE (such as by using communication manager 140, reception component 702, and/or paging component 708, depicted in FIG. 7) may receive a second indication of a paging range, wherein the paging range includes a fifth list of one or more cells to be used for the paging procedure and, for each cell, of the one or more cells, a sixth list of one of more SSBs to be used for the paging procedure, as described above.

Process 500 may include additional aspects, such as any single aspect or any combination of aspects described below or in connection with one or more other processes described elsewhere herein.

In a first additional aspect, the first preferred paging range is associated with a first quality of service indicator.

In a second additional aspect, alone or in combination with the first aspect, process 500 includes transmitting a third indication of a second preferred paging range associated with the UE, wherein the second preferred paging range is associated with a second quality of service indicator different from the first quality of service indicator.

In a third additional aspect, alone or in combination with one or more of the first and second aspects, the first preferred paging range indicates at least one of for each preferred cell, of the one or more preferred cells, a global unique cell identifier for that preferred cell, or for each SSB, of the one or more SSBs, an SSB beam identifier.

In a fourth additional aspect, alone or in combination with one or more of the first through third aspects, the first indication indicates a first time of day associated with the first preferred paging range.

In a fifth additional aspect, alone or in combination with one or more of the first through fourth aspects, process 500 includes transmitting a third indication of a second preferred paging range associated with the UE, wherein the second preferred paging range is associated with a second time of data different from the first time of day.

In a sixth additional aspect, alone or in combination with one or more of the first through fifth aspects, the first preferred paging range indicates a time range during which there are no preferred cells associated with the paging procedure.

In a seventh additional aspect, alone or in combination with one or more of the first through sixth aspects, at least one of the first indication is transmitted via a non-access stratum registration request message, the second indication is received via a non-access stratum registration accept message, or a third indication of an agreed paging range associated with the UE is transmitted via a non-access stratum registration complete message, wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

In an eighth additional aspect, alone or in combination with one or more of the first through seventh aspects, process 500 includes identifying the first preferred paging range using at least one of an artificial intelligence model or a machine learning model associated with the UE.

In a ninth additional aspect, alone or in combination with one or more of the first through eighth aspects, the paging range is identified using at least one of an artificial intelligence model or a machine learning model associated with a core network.

In a tenth additional aspect, alone or in combination with one or more of the first through ninth aspects, process 500 includes transmitting a third indication of an agreed paging range associated with the UE, wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

In an eleventh additional aspect, alone or in combination with one or more of the first through tenth aspects, the third indication is transmitted via a non-access stratum registration complete message.

In a twelfth additional aspect, alone or in combination with one or more of the first through eleventh aspects, process 500 includes receiving a paging message associated with the paging procedure via at least one cell and at least one SSB associated with the paging range.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, at a network node or an apparatus of a network node that supports a paging range for a UE in accordance with the present disclosure. Example process 600 is an example where the apparatus or the network node (for example, network node 110) performs operations associated with transmitting a paging message using fewer than all cells and/or SSBs associated with a TA.

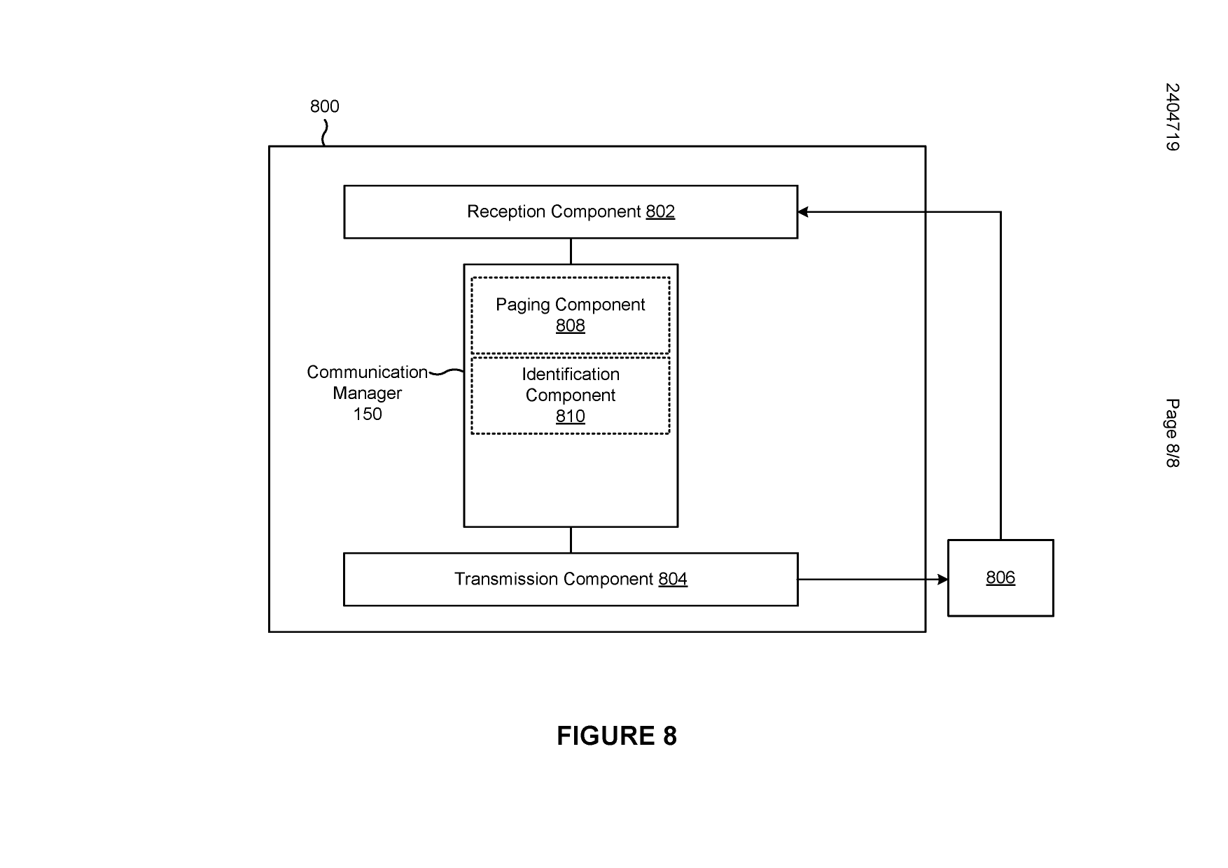

As shown in FIG. 6, in some aspects, process 600 may include receiving, from a UE, a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure (block 610). For example, the network node (such as by using communication manager 150, reception component 802, and/or paging component 808, depicted in FIG. 8) may receive, from a UE, a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure, as described above.

As further shown in FIG. 6, in some aspects, process 600 may include transmitting, to the UE, a second indication of a paging range, wherein the paging range includes a fifth list of one or more cells to be used for the paging procedure and, for each cell, of the one or more cells, a sixth list of one of more SSBs to be used for the paging procedure (block 620). For example, the network node (such as by using communication manager 150, transmission component 804, and/or paging component 808, depicted in FIG. 8) may transmit, to the UE, a second indication of a paging range, wherein the paging range includes a fifth list of one or more cells to be used for the paging procedure and, for each cell, of the one or more cells, a sixth list of one of more SSBs to be used for the paging procedure, as described above. In some aspects, the paging range includes a fifth list of one or more cells to be used for the paging procedure and, for each cell, of the one or more cells, a sixth list of one of more SSBs to be used for the paging procedure.

Process 600 may include additional aspects, such as any single aspect or any combination of aspects described below or in connection with one or more other processes described elsewhere herein.

In a first additional aspect, the first preferred paging range is associated with a first quality of service indicator.

In a second additional aspect, alone or in combination with the first aspect, process 600 includes receiving, from the UE, a third indication of a second preferred paging range associated with the UE, wherein the second preferred paging range is associated with a second quality of service indicator different from the first quality of service indicator.

In a third additional aspect, alone or in combination with one or more of the first and second aspects, the first preferred paging range indicates at least one of for each preferred cell, of the one or more preferred cells, a global unique cell identifier for that preferred cell, or for each SSB, of the one or more SSBs, an SSB beam identifier.

In a fourth additional aspect, alone or in combination with one or more of the first through third aspects, the first indication indicates a first time of day associated with the first preferred paging range.

In a fifth additional aspect, alone or in combination with one or more of the first through fourth aspects, process 600 includes receiving, from the UE, a third indication of a second preferred paging range associated with the UE, wherein the second preferred paging range is associated with a second time of data different from the first time of day.

In a sixth additional aspect, alone or in combination with one or more of the first through fifth aspects, the first preferred paging range indicates a time range during which there are no preferred cells associated with the paging procedure.

In a seventh additional aspect, alone or in combination with one or more of the first through sixth aspects, at least one of the first indication is received via a non-access stratum registration request message, the second indication is transmitted via a non-access stratum registration accept message, or a third indication of an agreed paging range associated with the UE is transmitted via a non-access stratum registration complete message, wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

In an eighth additional aspect, alone or in combination with one or more of the first through seventh aspects, the first preferred paging range is identified using at least one of an artificial intelligence model or a machine learning model associated with the UE.

In a ninth additional aspect, alone or in combination with one or more of the first through eighth aspects, process 600 includes identifying the paging range using at least one of an artificial intelligence model or a machine learning model associated with the network node.

In a tenth additional aspect, alone or in combination with one or more of the first through ninth aspects, process 600 includes receiving, from the UE, a third indication of an agreed paging range associated with the UE, wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

In an eleventh additional aspect, alone or in combination with one or more of the first through tenth aspects, the third indication is received via a non-access stratum registration complete message.

In a twelfth additional aspect, alone or in combination with one or more of the first through eleventh aspects, process 600 includes transmitting, to the UE, a paging message associated with the paging procedure via at least one cell and at least one SSB associated with the paging range.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports a paging range for a UE in accordance with the present disclosure. The apparatus 700 may be a UE, or a UE may include the apparatus 700. In some aspects, the apparatus 700 includes a reception component 702, a transmission component 704, and a communication manager 140, which may be in communication with one another (for example, via one or more buses). As shown, the apparatus 700 may communicate with another apparatus 706 (such as a UE, a network node, or another wireless communication device) using the reception component 702 and the transmission component 704.

In some aspects, the apparatus 700 may be configured to and/or operable to perform one or more operations described herein in connection with FIG. 4. Additionally or alternatively, the apparatus 700 may be configured to and/or operable to perform one or more processes described herein, such as process 500 of FIG. 5. In some aspects, the apparatus 700 may include one or more components of the UE 120 described above in connection with FIGS. 1 and 2.

The reception component 702 may receive communications, such as reference signals, control information, and/or data communications, from the apparatus 706. The reception component 702 may provide received communications to one or more other components of the apparatus 700, such as the communication manager 140. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, one or more modems, one or more demodulators, one or more MIMO detectors, one or more receive processors, one or more controllers/processors, and/or one or more memories of the UE 120 described above in connection with FIGS. 1 and 2.

The transmission component 704 may transmit communications, such as reference signals, control information, and/or data communications, to the apparatus 706. In some aspects, the communication manager 140 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, one or more modems, one or more modulators, one or more transmit MIMO processors, one or more transmit processors, one or more controllers/processors, and/or one or more memories of the UE 120 described above in connection with FIGS. 1 and 2. In some aspects, the transmission component 704 may be co-located with the reception component 702 in one or more transceivers.

The communication manager 140 may transmit or may cause the transmission component 704 to transmit a first indication of a first preferred paging range associated with the UE and an alternate preferred paging range associated with the UE wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure. The communication manager 140 may receive or may cause the reception component 702 to receive a second indication of a paging range wherein the paging range includes a fifth list of one or more cells to be used for the paging procedure and, for each cell, of the one or more cells, a sixth list of one of more SSBs to be used for the paging procedure. In some aspects, the communication manager 140 may perform one or more operations described elsewhere herein as being performed by one or more components of the communication manager 140.

The communication manager 140 may include one or more controllers/processors and/or one or more memories of the UE 120 described above in connection with FIGS. 1 and 2. In some aspects, the communication manager 140 includes a set of components, such as a paging component 708, and/or an identification component 710. Alternatively, the set of components may be separate and distinct from the communication manager 140. In some aspects, one or more components of the set of components may include or may be implemented within one or more controllers/processors and/or one or more memories of the UE 120 described above in connection with FIGS. 1 and 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 704 and/or the paging component 708 may transmit a first indication of a first preferred paging range associated with the UE and an alternate preferred paging range associated with the UE wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure. The reception component 702 and/or the paging component 708 may receive a second indication of a paging range wherein the paging range includes a fifth list of one or more cells to be used for the paging procedure and, for each cell, of the one or more cells, a sixth list of one of more SSBs to be used for the paging procedure.

The transmission component 704 and/or the paging component 708 may transmit a third indication of a second preferred paging range associated with the UE, wherein the second preferred paging range is associated with a second quality of service indicator different from the first quality of service indicator.

The transmission component 704 and/or the paging component 708 may transmit a third indication of a second preferred paging range associated with the UE, wherein the second preferred paging range is associated with a second time of data different from the first time of day.

The identification component 710 and/or the paging component 708 may identify the first preferred paging range using at least one of an artificial intelligence model or a machine learning model associated with the UE.

The transmission component 704 and/or the paging component 708 may transmit a third indication of an agreed paging range associated with the UE, wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

The reception component 702 and/or the paging component 708 may receive a paging message associated with the paging procedure via at least one cell and at least one SSB associated with the paging range.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

FIG. 8 is a diagram of an example apparatus 800 for wireless communication that supports a paging range for a UE in accordance with the present disclosure. The apparatus 800 may be a network node, or a network node may include the apparatus 800. In some aspects, the apparatus 800 includes a reception component 802, a transmission component 804, and a communication manager 150, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIG. 4. Additionally or alternatively, the apparatus 800 may be configured to and/or operable to perform one or more processes described herein, such as process 600 of FIG. 6. In some aspects, the apparatus 800 may include one or more components of the network node 110 described above in connection with FIGS. 1 and 2.

The reception component 802 may receive communications, such as reference signals, control information, and/or data communications, from the apparatus 806. The reception component 802 may provide received communications to one or more other components of the apparatus 800, such as the communication manager 150. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, one or more modems, one or more demodulators, one or more MIMO detectors, one or more receive processors, one or more controllers/processors, and/or one or more memories of the network node 110 described above in connection with FIGS. 1 and 2.

The transmission component 804 may transmit communications, such as reference signals, control information, and/or data communications, to the apparatus 806. In some aspects, the communication manager 150 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, and/or one or more memories of the network node 110 described above in connection with FIGS. 1 and 2. In some aspects, the transmission component 804 may be co-located with the reception component 802 in one or more transceivers.

The communication manager 150 may receive or may cause the reception component 802 to receive, from a UE, a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure. The communication manager 150 may transmit or may cause the transmission component 804 to transmit, to the UE, a second indication of a paging range, wherein the paging range includes a fifth list of one or more cells to be used for the paging procedure and, for each cell, of the one or more cells, a sixth list of one of more SSBs to be used for the paging procedure. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node 110 described above in connection with FIGS. 1 and 2. In some aspects, the communication manager 150 includes a set of components, such as a paging component 808, and/or an identification component 810. Alternatively, the set of components may be separate and distinct from the communication manager 150. In some aspects, one or more components of the set of components may include or may be implemented within one or more controllers/processors, one or more memories, one or more schedulers, and/or one or more communication units of the network node 110 described above in connection with FIGS. 1 and 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 and/or the paging component 808 may receive, from a UE, a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred SSBs associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure. The transmission component 804 and/or the paging component 808 may transmit, to the UE, a second indication of a paging range, wherein the paging range includes a fifth list of one or more cells to be used for the paging procedure and, for each cell, of the one or more cells, a sixth list of one of more SSBs to be used for the paging procedure.

The reception component 802 and/or the paging component 808 may receive, from the UE, a third indication of a second preferred paging range associated with the UE, wherein the second preferred paging range is associated with a second quality of service indicator different from the first quality of service indicator.

The reception component 802 and/or the paging component 808 may receive, from the UE, a third indication of a second preferred paging range associated with the UE, wherein the second preferred paging range is associated with a second time of data different from the first time of day.

The identification component 810 and/or the paging component 808 may identify the paging range using at least one of an artificial intelligence model or a machine learning model associated with the network node.

The reception component 802 and/or the paging component 808 may receive, from the UE, a third indication of an agreed paging range associated with the UE, wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

The transmission component 804 and/or the paging component 808 may transmit, to the UE, a paging message associated with the paging procedure via at least one cell and at least one SSB associated with the paging range.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed at a user equipment (UE), comprising: transmitting a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred synchronization signal blocks (SSBs) associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and receiving a second indication of a paging range, wherein the paging range includes a fifth list of one or more cells to be used for the paging procedure and, for each cell, of the one or more cells, a sixth list of one of more SSBs to be used for the paging procedure.

Aspect 2: The method of Aspect 1, wherein the first preferred paging range is associated with a first quality of service indicator.

Aspect 3: The method of Aspect 2, further comprising: transmitting a third indication of a second preferred paging range associated with the UE, wherein the second preferred paging range is associated with a second quality of service indicator different from the first quality of service indicator.

Aspect 4: The method of any of Aspects 1-3, wherein the first preferred paging range indicates at least one of: for each preferred cell, of the one or more preferred cells, a global unique cell identifier for that preferred cell, or for each SSB, of the one or more SSBs, an SSB beam identifier.

Aspect 5: The method of any of Aspects 1-4, wherein the first indication indicates a first time of day associated with the first preferred paging range.

Aspect 6: The method of Aspect 5, further comprising: transmitting a third indication of a second preferred paging range associated with the UE, wherein the second preferred paging range is associated with a second time of data different from the first time of day.

Aspect 7: The method of any of Aspects 1-6, wherein the first preferred paging range indicates a time range during which there are no preferred cells associated with the paging procedure.

Aspect 8: The method of any of Aspects 1-7, wherein at least one of: the first indication is transmitted via a non-access stratum registration request message, the second indication is received via a non-access stratum registration accept message, or a third indication of an agreed paging range associated with the UE is transmitted via a non-access stratum registration complete message, wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

Aspect 9: The method of any of Aspects 1-8, further comprising identifying the first preferred paging range using at least one of an artificial intelligence model or a machine learning model associated with the UE.

Aspect 10: The method of any of Aspects 1-9, wherein the paging range is identified using at least one of an artificial intelligence model or a machine learning model associated with a core network.

Aspect 11: The method of any of Aspects 1-10, further comprising transmitting a third indication of an agreed paging range associated with the UE, wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

Aspect 12: The method of Aspect 11, wherein the third indication is transmitted via a non-access stratum registration complete message.

Aspect 13: The method of any of Aspects 1-12, further comprising receiving a paging message associated with the paging procedure via at least one cell and at least one SSB associated with the paging range.

Aspect 14: A method of wireless communication performed at a network node, comprising: receiving, from a user equipment (UE), a first indication of a first preferred paging range associated with the UE and an alternate preferred paging range associated with the UE, wherein the first preferred paging range includes a first list of one or more preferred cells associated with a paging procedure and, for each preferred cell, of the one or more preferred cells, a second list of one of more preferred synchronization signal blocks (SSBs) associated with the paging procedure, and wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and transmitting, to the UE, a second indication of a paging range, wherein the paging range includes a fifth list of one or more cells to be used for the paging procedure and, for each cell, of the one or more cells, a sixth list of one of more SSBs to be used for the paging procedure.

Aspect 15: The method of Aspect 14, wherein the first preferred paging range is associated with a first quality of service indicator.

Aspect 16: The method of Aspect 15, further comprising: receiving, from the UE, a third indication of a second preferred paging range associated with the UE, wherein the second preferred paging range is associated with a second quality of service indicator different from the first quality of service indicator.

Aspect 17: The method of any of Aspects 14-16, wherein the first preferred paging range indicates at least one of: for each preferred cell, of the one or more preferred cells, a global unique cell identifier for that preferred cell, or for each SSB, of the one or more SSBs, an SSB beam identifier.

Aspect 18: The method of any of Aspects 14-17, wherein the first indication indicates a first time of day associated with the first preferred paging range.

Aspect 19: The method of Aspect 18, further comprising: receiving, from the UE, a third indication of a second preferred paging range associated with the UE, wherein the second preferred paging range is associated with a second time of data different from the first time of day.

Aspect 20: The method of any of Aspects 14-19, wherein the first preferred paging range indicates a time range during which there are no preferred cells associated with the paging procedure.

Aspect 21: The method of any of Aspects 14-20, wherein at least one of: the first indication is received via a non-access stratum registration request message, the second indication is transmitted via a non-access stratum registration accept message, or a third indication of an agreed paging range associated with the UE is transmitted via a non-access stratum registration complete message, wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

Aspect 22: The method of any of Aspects 14-21, wherein the first preferred paging range is identified using at least one of an artificial intelligence model or a machine learning model associated with the UE.

Aspect 23: The method of any of Aspects 14-22, further comprising identifying the paging range using at least one of an artificial intelligence model or a machine learning model associated with the network node.

Aspect 24: The method of any of Aspects 14-23, further comprising receiving, from the UE, a third indication of an agreed paging range associated with the UE, wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

Aspect 25: The method of Aspect 24, wherein the third indication is received via a non-access stratum registration complete message.

Aspect 26: The method of any of Aspects 14-25, further comprising transmitting, to the UE, a paging message associated with the paging procedure via at least one cell and at least one SSB associated with the paging range.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
transmit a first indication of a first preferred paging range associated with the UE and an alternate preferred paging range associated with the UE,
wherein the first preferred paging range includes a first list of one or more preferred cells associated with a paging procedure and, for each preferred cell, of the one or more preferred cells, a second list of one of more preferred synchronization signal blocks (SSBs) associated with the paging procedure, and
wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and
receive a second indication of a paging range,
wherein the paging range includes a fifth list of one or more cells to be used for the paging procedure and, for each cell, of the one or more cells, a sixth list of one of more SSBs to be used for the paging procedure.

2. The apparatus of claim 1, wherein the first preferred paging range is associated with a first quality of service indicator.

3. The apparatus of claim 2, wherein at least one processor of the one or more processors is configured to cause the UE to:
transmit a third indication of a second preferred paging range associated with the UE,
wherein the second preferred paging range is associated with a second quality of service indicator different from the first quality of service indicator.

4. The apparatus of claim 1, wherein the first preferred paging range indicates at least one of:
for each preferred cell, of the one or more preferred cells, a global unique cell identifier for that preferred cell, or
for each SSB, of the one or more SSBs, an SSB beam identifier.

5. The apparatus of claim 1, wherein the first indication indicates a first time of day associated with the first preferred paging range.

6. The apparatus of claim 5, wherein at least one processor of the one or more processors is further configured to cause the UE to:
transmit a third indication of a second preferred paging range associated with the UE,
wherein the second preferred paging range is associated with a second time of data different from the first time of day.

7. The apparatus of claim 1, wherein the first preferred paging range indicates a time range during which there are no preferred cells associated with the paging procedure.

8. The apparatus of claim 1, wherein at least one of:
the first indication is transmitted via a non-access stratum registration request message,
the second indication is received via a non-access stratum registration accept message, or
a third indication of an agreed paging range associated with the UE is transmitted via a non-access stratum registration complete message,
wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

9. The apparatus of claim 1, wherein at least one processor of the one or more processors is further configured to cause the UE to identify the first preferred paging range using at least one of an artificial intelligence model or a machine learning model associated with the UE.

10. The apparatus of claim 1, wherein the paging range is identified using at least one of an artificial intelligence model or a machine learning model associated with a core network.

11. The apparatus of claim 1, wherein at least one processor of the one or more processors is further configured to cause the UE to transmit a third indication of an agreed paging range associated with the UE,
wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

12. The apparatus of claim 11, wherein the third indication is transmitted via a non-access stratum registration complete message.

13. The apparatus of claim 1, wherein at least one processor of the one or more processors is further configured to cause the UE to receive a paging message associated with the paging procedure via at least one cell and at least one SSB associated with the paging range.

14. An apparatus for wireless communication at a network node, comprising:
one or more memories storing processor-executable code; and
one or more processors coupled with the one or more memories, at least one processor of the one or more processors configured to cause the network node to:
receive, from a user equipment (UE), a first indication of a first preferred paging range associated with the UE and an alternate preferred paging range associated with the UE,
wherein the first preferred paging range includes a first list of one or more preferred cells associated with a paging procedure and, for each preferred cell, of the one or more preferred cells, a second list of one of more preferred synchronization signal blocks (SSBs) associated with the paging procedure, and
wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and
transmit, to the UE, a second indication of a paging range,
wherein the paging range includes a fifth list of one or more cells to be used for the paging procedure and, for each cell, of the one or more cells, a sixth list of one of more SSBs to be used for the paging procedure.

15. The apparatus of claim 14, wherein the first preferred paging range indicates at least one of:
for each preferred cell, of the one or more preferred cells, a global unique cell identifier for that preferred cell, or
for each SSB, of the one or more SSBs, an SSB beam identifier.

16. The apparatus of claim 14, wherein at least one of:
the first indication is received via a non-access stratum registration request message,
the second indication is transmitted via a non-access stratum registration accept message, or
a third indication of an agreed paging range associated with the UE is transmitted via a non-access stratum registration complete message,
wherein the agreed paging range includes a seventh list of one or more cells agreed to by the UE and a core network entity for the paging procedure, and, for each cell agreed to by the UE and the core network entity, of the one or more cells agreed to by the UE and the core network entity, an eighth list of one of more SSBs agreed to by the UE and a core network entity for the paging procedure.

17. The apparatus of claim 14, wherein at least one processor of the one or more processors is further configured to cause the network node to identify the paging range using at least one of an artificial intelligence model or a machine learning model associated with the network node.

18. The apparatus of claim 14, wherein at least one processor of the one or more processors is further configured to cause the network node to transmit, to the UE, a paging message associated with the paging procedure via at least one cell and at least one SSB associated with the paging range.

19. A method of wireless communication performed at a user equipment (UE), comprising:
transmitting a first indication of a first preferred paging range associated with the UE and an alternate preferred paging range associated with the UE,
wherein the first preferred paging range includes a first list of one or more preferred cells associated with a paging procedure and, for each preferred cell, of the one or more preferred cells, a second list of one of more preferred synchronization signal blocks (SSBs) associated with the paging procedure, and
wherein the alternate preferred paging range includes a third list of one or more alternate preferred cells to be used if there is a paging failure and, for each alternate preferred cell, of the one or more alternate preferred cells, a fourth list of one of more alternate preferred SSBs to be used if there is the paging failure; and
receiving a second indication of a paging range,
wherein the paging range includes a fifth list of one or more cells to be used for the paging procedure and, for each cell, of the one or more cells, a sixth list of one of more SSBs to be used for the paging procedure.

20. The method of claim 19, wherein the first preferred paging range is associated with a first quality of service indicator,
wherein the method further comprises transmitting a third indication of a second preferred paging range associated with the UE, and
wherein the second preferred paging range is associated with a second quality of service indicator different from the first quality of service indicator.
